(19) United States
(12) Patent Application Publication
(10) Pub. No.: US 2007/0182180 A1
(43) Pub. Date: Aug. 9, 2007

(54) Connection between two parts, and associated connection method

(75) Inventors: Konrad Eipper, Rottenburg (DE); Bernd Klepsch, Bremen (DE); Juergen Knothe, Gartringen (DE); Bernhard Spies, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRISLER AG, Stuttgart (DE)

(21) Appl. No.: 10/567,468

(22) PCT Filed: May 8, 2004
(86) PCT No.: PCT/EP04/08778

§ 371 Date: Aug. 31, 2006

(30) Foreign Application Priority Data
Aug. 7, 2003 (DE) 103 36 189.8

(51) Int. Cl. B60P 3/00

(52) U.S. Cl. 296/2

(57) ABSTRACT

A connection (4) between two parts (2, 3), in particular in a motor vehicle. The two parts (2, 3) are connected to one another in a connection zone (5) via a plastic connection (6) consisting of an injection-molded plastic (8). Additionally, the two parts (2, 3) are connected to one another in the connection zone (5) via an adhesive connection (7) consisting of a cured adhesive (9).

### BACKGROUND AND SUMMARY OF THE INVENTION

The present invention relates to a connection between two parts, in particular in a motor vehicle.

Gillman Patent document DE 100 29 411 A1 discloses a connection between two metal parts, in which a plastic connection which consists of an injection-molded plastic and via which the two parts are connected to one another is formed in a connection zone. In order for the two parts to also be connected positively to one another with the aid of the plastic connection, one part may have a plurality of passage orifices in the connection zone. The orifices are filled with plastic.

In specific applications, particularly in the automobile sector, it was shown that connections of this type often do not achieve the desired stability, since, for example, the operating conditions, such as, for example, oscillations, which occur when a motor vehicle is in operation, are highly detrimental to the durability of the connection.

The present invention is concerned with the problem of specifying, for a connection of the type initially mentioned, an improved embodiment which, in particular, possesses increased stability.

The invention is based on the concept of providing, in addition to the plastic connection, an adhesive connection consisting of a cured adhesive. Adhesive connections can generate considerably greater adhesive effects on the surfaces of the parts than plastic connections and, in the cured state, possess a markedly higher load bearing capacity. Overall, the connection according to the invention possesses a markedly increased durability owing to the combination of the plastic connection with the adhesive connection.

The connection proposed according to the invention is particularly advantageous with regard to a production process in which a connection of this type is produced. When an adhesive connection is produced, the adhesive must first cure in order to generate the desired strength of the adhesive connection. During the curing process, the two parts to be connected to one another via the adhesive connection have to be fixed in relation to one another. In the connection according to the invention, this fixing can be implemented rather quickly with the aid of the plastic connection which has its strength immediately after the cooling of the injection-molded plastic. It is thereby possible, in particular, after the adhesive has been applied and after the plastic connection has been made, to process the parts further and/or to deliver them to other processing stations while the adhesive is not yet cured. It is assumed, in this case, that, during the time-consuming curing process, the connection is subjected to only a comparatively light load as a result of the further processing of the parts. However, these light loads can readily be absorbed by the plastic connection. Consequently, the two parts are fixed in relation to one another in the connection zone during the curing process.

It is particularly advantageous, in this case, to have an embodiment in which the adhesive connection is encased by the plastic connection. As regards the method, this means that even a flowable adhesive may be used for producing the adhesive connection. This is because, after the injection molding of the plastic connection, the adhesive is encased and can no longer leave the connection zone. A soiling of the parts and of the surroundings of the parts by emerging adhesive can thereby be avoided. The connection according to the invention is therefore clean even though it works with adhesive. Furthermore, the adhesive connection is protected from environmental influences by the plastic connection even after the curing of the adhesive.

In particular, it is possible to design the plastic used for the plastic connection in light of the ambient conditions occurring during the respective use of the parts connected to one another, in such a way that the adhesive connection is permanently protected from aggressive ambient conditions.

A further particular advantage can be achieved in the present invention when an adhesive, the curing process of which can be initiated thermally, is used. The process parameters of the connection method can then expediently be selected such that the curing process is initiated by the injection molding of the plastic. This procedure makes it possible to dispense with an additional thermal control of the connection which is required in conventional adhesive connections in order to initiate the curing or gelling of the adhesive. The outlay in terms of the production of the connection according to the invention is thus reduced.

Further important features and advantages of the invention may be gathered from the subclaims, from the drawings and from the associated figure description with reference to the drawings.

It goes without saying that the features mentioned above and those yet to be explained below can be used not only in the combination specified in each case, but also in other combinations or alone, without departing from the scope of the present invention.

A preferred exemplary embodiment of the invention is illustrated in the drawings and is explained in more detail in the following description, the same reference symbols relating to identical or functionally identical or similar parts.

### BRIEF DESCRIPTION OF THE DRAWINGS

FIG. 1 shows two parts to be connected;

FIG. 2 shows adhesive applied;

FIG. 3 illustrates the parts in the molding;

FIG. 4 illustrates the injected plastic; and

FIG. 5 shows the formed composite.

### DETAILED DESCRIPTION

FIG. 5 shows a composite part 1 which is composed of two individual parts, to be precise, of a first part 2 and of a second part 3, the two parts 2, 3 being connected to one another via the aid of a connection 4 according to the invention. The parts 2, 3 may be, as here, metal sheets which are provided at least on one side with a surface coating.

The parts 2, 3 are, in particular, coil-coated metal sheets which are delivered on rolls.

The connection 4 according to the invention includes in a connection zone 5 identified by a curly bracket, a plastic connection 6 and an adhesive connection 7. The plastic connection 6 consists of an injection-molded plastic 8 and connects the two parts 2, 3 to one another in the connection zone 5. In contrast, the adhesive connection 7 consists of a cured adhesive 9 which likewise connects the two parts 2, 3 to one another in the connection zone 5. In the connection zone 5, the two parts 2, 3 overlap one another in each case at an outer edge 10, 11.

In the illustrated embodiment of the connection 4 according to the invention, the adhesive 9 is arranged between the edge regions 10, 11, thus resulting in particularly large contact surfaces for the adhesive 9.

In the particularly advantageous embodiment shown here, the adhesive connection 6 is made in such a way that it surrounds the adhesive connection 7. In particular, the adhesive connection 7 is encased by the plastic connection 6. In the state shown in FIG. 5, the adhesive connection 7 is thus effectively protected against harmful ambient conditions.

In order to improve the connecting effect of the plastic connection 6, in the illustrated embodiment shown here the parts 2, 3 are provided in each case with at least one passage orifice 12 in the region of the connection zone 5. The passage orifice is filled with the plastic 8 of the plastic connection 6. The passage orifices 12 are in this case arranged within the plastic connection 6. It is clear that the two parts 2, 3 may expediently be provided in each case with a plurality of such passage orifices along the connection zone 5.

By virtue of this measure, the portion of the plastic connection 6 is arranged on one side of the parts 2, 3 is connected to or formed in one piece with the portion of the plastic connection 6 is arranged on the other side of the parts 2, 3. The plastic within the respective passage orifice 12 forms a kind of plastic rivet. The passage orifices 12 filled with the plastic 8 thus allow a positive connection between the parts 2, 3 via the plastic connection 6.

The connection 4 according to the invention can possess a particularly high strength and a particularly high durability owing to the combination of the plastic connection 6 with the adhesive connection 7. Furthermore, the encased arrangement shown here makes it possible to protect the adhesive connection 7 with the aid of the plastic connection 6.

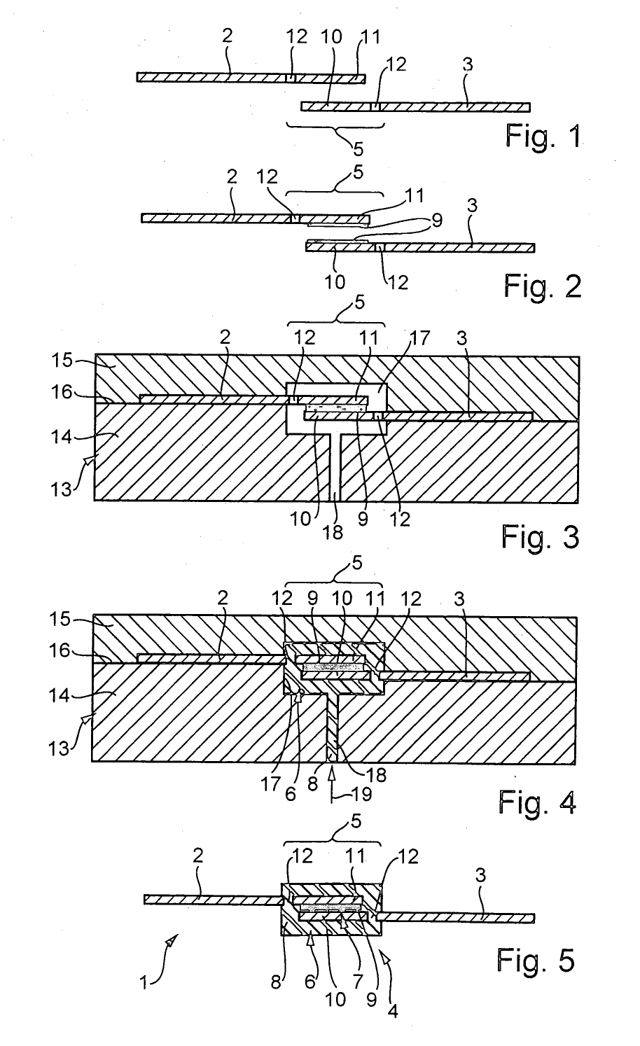

A method according to the invention for the connection of the two parts 2, 3 is explained in more detail below with reference to FIG. 1 to 5:

FIG. 1 shows an initial situation, in which the two parts 2, 3 are already provided with the passage orifices 12.

According to FIG. 2, the adhesive 9 is applied in a not yet cured state in the connection zone 5 at the edge regions 10, 11 of the parts 2, 3. In this case, it is possible, in principle, to apply the adhesive 9 at both edge regions 10, 11. It may likewise be expedient, in other embodiments, to apply the adhesive 9 to only one of the parts 2, 3. The curable adhesive 9 is expediently a synthetic resin.

The two parts 2, 3, then, are positioned in relation to one another such as they are to be fastened to one another by the connection 4 after the latter has been made. Here, according to FIG. 3, this positioning is achieved with the aid of an injection mold 13, into which the parts 2, 3 are inserted at least in the region of the connection zone 5. The injection mold 13 consists, for example, of two halves 14 and 15 which come to bear one against the other at a parting line 16. The closed injection mold 13 contains, in the region of the connection zone 5, a cavity 17 which serves for forming the plastic connection 6. The injection mold 13 contains at least one injection duct 18 which issues into the cavity 17. In this state, the adhesive 9 is not yet cured, that is to say the adhesive connection 7 is not yet formed.

According to FIG. 4, the plastic 8 can be injected into the cavity 17 through the at least one injection duct 18, as shown by the arrow 19 until it fills the cavity 17. It is clear that corresponding venting orifices may be provided. The injected plastic 8 in this case also passes through the passage orifices 12. During the injection molding of the plastic 8, the adhesive 9 is still not cured, so that the adhesive connection 7 is not yet formed.

After the solidification of the injected plastic 8, the plastic connection 6 is formed so that the parts 2, 3 can then be again removed from the injection mold 13. Advantageously, the parts 2, 3 connected to one another via the plastic connection 6 may then be delivered for further processing operations, even though, as before, the adhesive 9 is not yet cured.

According to a particularly advantageous embodiment, an adhesive 9 is used to form the adhesive connection 7. The curing process is initiated thermally and, after its initiation, proceeds essentially independently, even at lower temperatures, until a complete curing or solidification of the adhesive 9. The adhesive 9 applied to the parts 2, 3 must therefore be heated until the curing process is initiated. The present invention, then, makes use of the knowledge that heat is also required for the injection molding of the plastic 8 which is expediently a thermoplastic. Therefore, in the present invention, the process parameters for the injection molding operation and the initiating temperature of the adhesive 9 are coordinated with one another such that the curing process is initiated by the injection molding of the plastic 8. That is, sufficient heat is supplied by the injection molding operation to the adhesive 9 to ensure that the latter reaches the initiating temperature.

Advantageously, in this case, the plastic connection 6 is also formed in such a way that it envelops the adhesive 9, with the result that the heat of the injection molding operation is concentrated toward the centrally arranged adhesive 9.

The curing operation started by the injection molding operation then proceeds independently, so that it is possible, in particular, to remove the parts 2, 3 from the injection mold 13 again and deliver them for further processing while the adhesive connection 7 is gradually forming as a result of the curing of the adhesive 9.

The encased accommodation of the adhesive 9 or of the adhesive connection 7 within the plastic connection 6 has the advantage that it allows a flowable adhesive 9 to be used. On account of the encasing, the adhesive 9 remains safely within the plastic connection 6 and therefore cannot emerge from the connection zone 5 until it is cured completely.

1-11. (canceled)

12. A connection arrangement between two parts connected to one another in a connection zone; comprising, in the connection zone,
a plastic connection including an injection-molded plastic for connecting said two parts; and
an adhesive connection including a cured adhesive also for connecting said two parts.

13. The connection as claimed in claim 12, wherein, the adhesive connection is encased within the plastic connection.

14. The connection as claimed in claim 12, wherein at least one of the parts has, in the connection zone, at least one passage orifice filled with the plastic of the plastic connection.

15. The connection as claimed in claim 12, wherein at least one of the parts consists of metal.

16. The connection as claimed in claim 12, wherein at least one of the parts has a surface coating at least on one side.

17. The connection as claimed in claim 12, wherein that at least one of the parts is a metal sheet.

18. The connection as claimed in claim 12, wherein at least one of the parts is a coil-coated metal sheet.

19. A method for the connection of two parts comprising the steps:
applying a curable adhesive in a connection zone of the two parts;
injection molding the two parts around with a plastic in the connection zone, in order to produce a plastic connection connecting the two parts to one another;
curing the adhesive while the two parts are being connected to one another via the plastic connection, in order to produce an adhesive connection also connecting the two parts to one another.

20. The method as claimed in claim 19,
a curing process of the adhesive is initiated thermally by the injection molding of the plastic.

21. The method as claimed in claim 19, wherein, during the curing of the adhesive, the two parts are removed from an injection mold into which they were inserted for the injection molding of the plastic at least in a region of the connection zone.

22. The method as claimed in claim 19, wherein the adhesive connection is encased within the plastic connection.

23. The method as claimed in claim 18, wherein at least one of the parts in metal.

24. The method as claimed in claim 18, wherein at least one of the parts has a surface coating at least on one side.

25. The method according to claim 8, wherein at least one of the parts is a metal sheet.

26. The method according to claim 8, wherein at least one of the parts is a coil-coated metal sheet.

27. The connection as claimed in claim 13, wherein at least one of the parts has, in the connection zone, at least one passage orifice filled with the plastic of the plastic connection.

28. The connection as claimed in claim 13, wherein at least one of the parts consists of metal.

29. The connection as claimed in claim 13, wherein at least one of the parts has a surface coating at least on one side.

30. The connection as claimed in claim 13, wherein at least one of the parts is a metal sheet.

31. The connection as claimed in claim 12, wherein at least one of the parts is a coil-coated metal sheet.
